(19) United States
(12) Patent Application Publication
(10) Pub. No.: US 2012/0111890 A1
(43) Pub. Date: May 10, 2012

(54) CONTAINER RETAINER

(76) Inventors: William Peter Herring, Bath (GB); James Moore, Somerset (GB)

(21) Appl. No.: 13/287,210

(22) Filed: Nov. 2, 2011

(30) Foreign Application Priority Data
Nov. 4, 2010 (GB) 1018640.1

(51) Int. Cl. B67D 7/06; A47G 29/08

(52) U.S. Cl. 222/180; 248/226.11

(57) ABSTRACT

A container retainer (5) is provided in which a locking member (11) which can be mounted on the neck of a bottle (3) is itself rotatably held in a bore (8) of a body part (9). The body part (9) is mountable on a suitable surface, such as a wall. With such an arrangement, it is possible to secure the locking member (11) to the bottle (3) by rotation, without having to rotate the bottle (3) itself, or the body part (9). The container retainer (5) then will normally be wall mounted, to form a liquid dispenser to dispense liquid from the bottle (3) or other container (3).

### BACKGROUND OF THE INVENTION

1. Field of the Invention

The present invention relates to the mounting of containers on surfaces, such as walls. For example, the present invention may be used in a wall-mounted dispenser for dispensing liquids such as soap from a container.

2. Summary of the Prior Art

Pump dispensers for dispensing liquid products are known. Such pump dispensers typically have a dispenser pump with a variable-volume pump chamber mounted on a container of liquid product. Some pump dispensers are designed to be mounted on a wall, for example above a sink in a public convenience or a hospital. Mounting the pump dispenser on a wall has the advantages of reducing clutter around the sink area and of improving hygiene, for example by reducing handling of the dispenser and by preventing it from being knocked into the sink or onto the floor.

With a wall-mounted pump dispenser, the pumping mechanism is typically a fixed feature, while the container of liquid, e.g. a bottle or a sachet, is removable to allow it to be refilled or replaced when empty. One method of retaining a container of liquid in a pump dispenser is to provide a screw through a sidewall of an aperture of the pumping mechanism which overlaps a neck of the container. The screw can be tightened to apply pressure to the neck of the container, thereby preventing the container from moving. However, it can be time consuming and/or difficult to turn the screw to a sufficient tightness to prevent slip of the container.

A second method of connecting the container of liquid to the wall-mounted pumping mechanism is to provide corresponding screw threads on a neck of the container and a fixed aperture of the pumping mechanism. This arrangement enables the container and the pumping mechanism to be brought into interlocking engagement by screwing the container into the aperture of the pumping mechanism. However, these retaining mechanisms cannot be rotated when mounted to a surface, and thus it is necessary to rotate the container relative to such mechanisms to lock the container in place. This can be difficult in cramped locations and preclude the use of certain container shapes and sizes.

### SUMMARY OF THE INVENTION

At its most general, the present invention provides a container retainer in which a locking member which can be mounted on the neck of a bottle is itself rotatably held in a body part, which body part is mountable on a suitable surface. With such an arrangement, it is possible to secure the locking member to the bottle by rotation without having to rotate the bottle itself, or the body part.

The container retainer then will normally be wall mounted, to form a liquid dispenser for dispensing liquid from the bottle or other container.

Thus, according to one aspect of the invention, there may be provided a container retainer for mounting a container on a surface, such as a wall. The container retainer comprises a body part having a bore therethrough, with a rotatable locking member extending into the bore, held therein so as to resist its movement in the direction of the axis of the bore. The locking member has an aperture through it for receiving a neck of the container, and means within the aperture for securing the locking member to a neck upon rotation of the locking member in the bore relative to the body part. The container retainer is also provided with means to mount the body part onto a surface.

The container retainer of the above aspect may have any one or, to the extent that they are compatible, any combination of the following optional features.

The locking member may be releasably held in the bore. This allows the container retainer to be assembled, and also to enable the locking member to be released e.g. for cleaning.

Such releasability may be provided by one or more lugs on the locking member which are receivable in a corresponding recess or recesses in the surface of the bore. Normally, the inter-engagement of the lug(s) and recess(es) holds the locking member in the bore. However, the lug(s) can be deformed clear of the recess(es) to permit the locking member to be removed from the bore.

Alternatively, releasability may be provided by a circlip or a setscrew on the locking member which engages a groove in the locking member, but is movable or releasable to disengage the groove and so release the locking member.

There may also be a flange on the locking member, which abuts against the body part adjacent one end of the bore, to resist axial movement of the locking member relative to the bore in one direction. The flange assists the lugs described above in retaining the locking member in the bore, but also has the effect of positioning the locking member at a predetermined axial position in the bore. This prevents the locking member moving axially, at least when it is not to be released. This effect may further be improved by providing a groove adjacent to the bore in which the flange is received, which then provides both axial and radial positioning of the locking member in the bore.

The locking member may have a grip part outside the bore to enable a user to rotate the locking member in the bore. The grip part may enable a user to more easily rotate the locking member to secure the locking member to the neck of a container. The grip part may also enable a user to apply a larger rotational force to the locking member relative to a locking member with no grip part, so that the locking member may be more tightly secured to the neck of the container.

The means for securing the locking member to the neck of the container may be a screw thread engagable with a corresponding screw thread on the neck of the container. Thus, rotation of the locking member in the bore relative to the body part will cause the locking member to engage with, and screw onto, the corresponding screw thread on the neck of the container, so that the locking member is secured to the neck of the container.

The means for securing the locking member to the neck of the container may comprise a plurality, e.g. two or more, screw threads with different internal diameters. For example, two or more separate screw threads may be disposed within the aperture of the locking member, each of the screw threads protruding a different distance into the aperture so that each of the screw threads has a different internal diameter (i.e. across the aperture of the locking member). The inclusion of a plurality of screw threads of different internal diameters means that the locking member is able to engage with screw threads on necks of different diameter, i.e. containers with different sized necks can be connected to the container retainer through the locking member.

The means for securing the locking member to the neck of the container may comprise a first screw thread with an internal diameter of 24 mm and a second screw thread with an internal diameter of 28 mm. Thus, containers with neck diameters of either 24 mm or 28 mm may be secured in the bore of the main body with the locking member.

Where a plurality of screw threads having different diameters are provided, they are arranged along an axial direction in the aperture with the largest diameter closest to the entrance to the aperture in which the neck is inserted.

A resilient member may be provided between the locking member and the bore to resist rotation of the locking member relative to the body part. Thus, to rotate the locking member relative to the body part, a user must apply a sufficient rotational force to overcome the resistance caused by the compression of the resilient member between the locking member and the bore.

Undesired rotation of the locking member within the bore of the body part may thus be prevented.

Normally, if liquids are to be dispensed from the container, a pump unit will be received in the aperture of the locking member, which can enter the neck of the container when the locking member is secured to that container, for pumping liquid out of the container.

The second aspect of the invention provides a kit of parts for forming a liquid dispenser, consisting of three elements. The first element is a support unit, comprising the body part and mounting means as described above, the second element is the locking member and holding means, and the third element is the pump unit. They may all be assembled together, to form a liquid dispenser to which a container of liquid may be mounted, to enable liquid to be dispensed therefrom.

### BRIEF DESCRIPTION OF THE DRAWINGS

Embodiments of the invention will now be described by way of example with reference to the accompanying drawings in which:

FIG. 1 shows schematically a side view of a liquid dispenser according to the invention;

FIG. 2 shows an isometric view of a liquid dispenser according to the invention;

FIG. 3 shows schematically a top view of a liquid dispenser according to the invention;

FIG. 4 shows schematically a front view of a liquid dispenser according to the invention;

FIG. 5 shows schematically a cross-section along line A-A of the liquid dispenser shown in FIG. 4;

FIG. 6 shows schematically region B of the cross-section shown in FIG. 5.

FIG. 7 shows schematically a cross-section along line A-A of the liquid dispenser shown in FIG. 4 according to a second embodiment of the invention.

### DETAILED DESCRIPTION

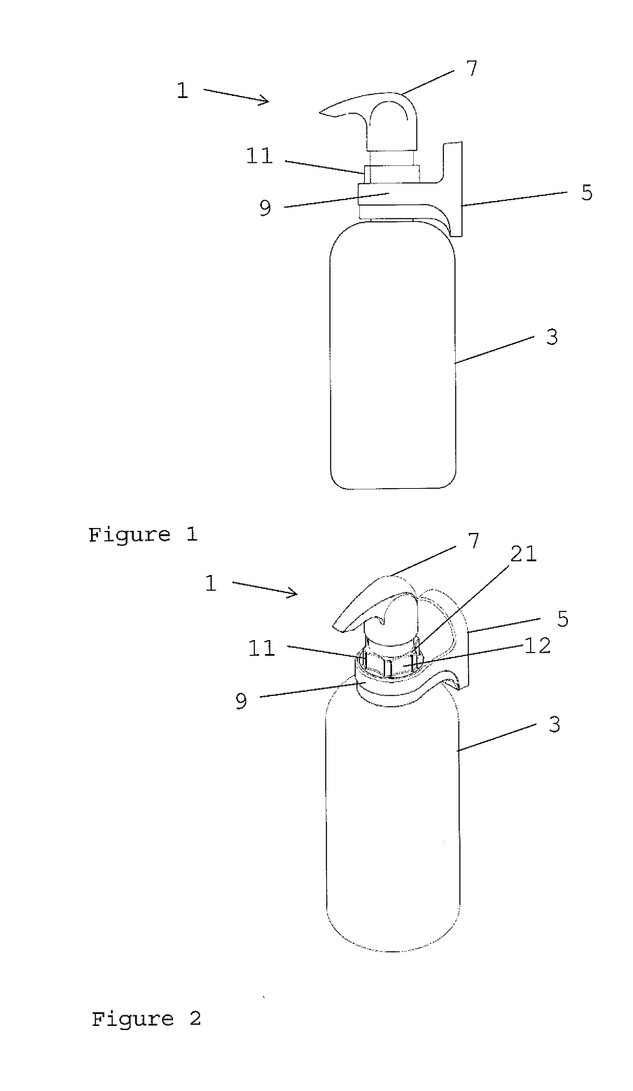

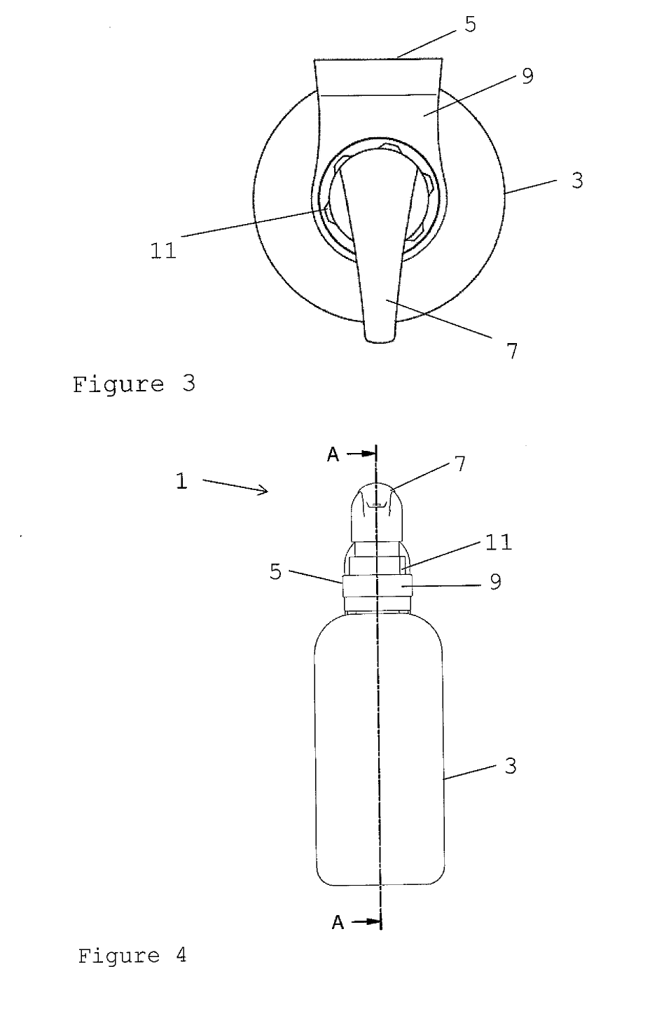

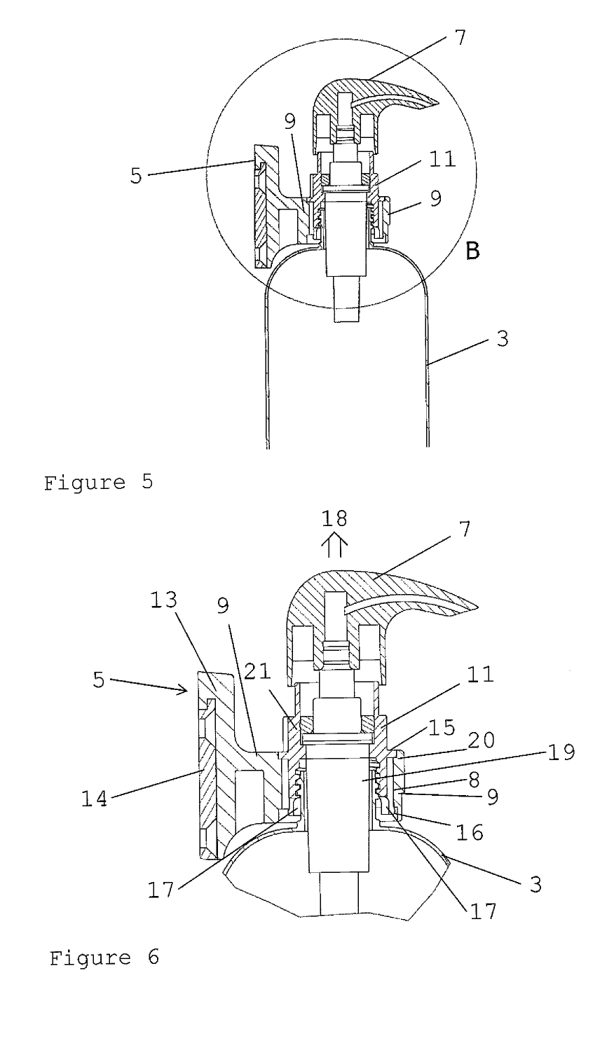

A liquid dispenser 1, as illustrated in FIGS. 1 to 4, comprises a container retainer 5 and a pump system 7 connected to the container retainer 5. The container retainer 5, which is discussed in more detail below, comprises a rotatable locking member 11 mounted within a bore in body part 9, and has the dual purposes of attaching a container 3 to the liquid dispenser 1 and of mounting the liquid dispenser 1 on a surface. The pump system 7, is arranged to dispense liquid from a container 3 retained by the container retainer 5, e.g. a bottle.

The container retainer 5, which is shown in more detail in FIG. 6, comprises a rotatable locking member 11 mounted within a bore 8 in a body part 9. The locked member 11 is releasably held within the bore by a flange 15 and lugs 17 so as to resist its movement in the direction of the axis of the bore 8. As can be seen from FIG. 6, the lugs 17 are received in a recess 16 extending circumferentially around the inner surface of the bore 8, at the lower axial end thereof, and similarly the flange 15 is received in a groove 20 at the upper axial end of the bore 8. Note that the groove abuts the flange 15 at both its lower surface, and its radially outer periphery, to limit movement of locking member 11 both axially and radially. The locking member 11 may be released from the bore when lugs 17 are manipulated into a non-securing configuration clear of the recess 16 and the locking member 11 is moved in direction 18 by a user.

The locking member 11 has an aperture 19 therethrough for receiving the neck of container 3, and is provided with a screw thread to secure said container upon rotation of the locking member 11 relative to body part 9. The locking member 11 has a grip part 21 outside the bore 8 to aid rotation of said member within the bore by a user. The grip part 21 may incorporate surface features, such as scallops 12 shown in FIG. 2, to aid gripping by a user.

The container retainer 5 also comprises a surface-mounting portion 13 connected to the body part 9 for mounting the liquid dispenser 1 on a wall. In this embodiment, the surface-mounting portion 13 is arranged to clip onto a corresponding surface-mounting section 14 already attached to a wall. However, the surface-mounting portion 13 may instead be directly attachable to a wall by known attachment means, e.g. adhesive, a nail, a screw or such-like.

The pump system 7, which is shown schematically in FIG. 6, may be a conventional pump system, as known to a person skilled in the art. The pump system gains access to the liquid contents of the container 3 through the aperture 19 of the locking member 11.

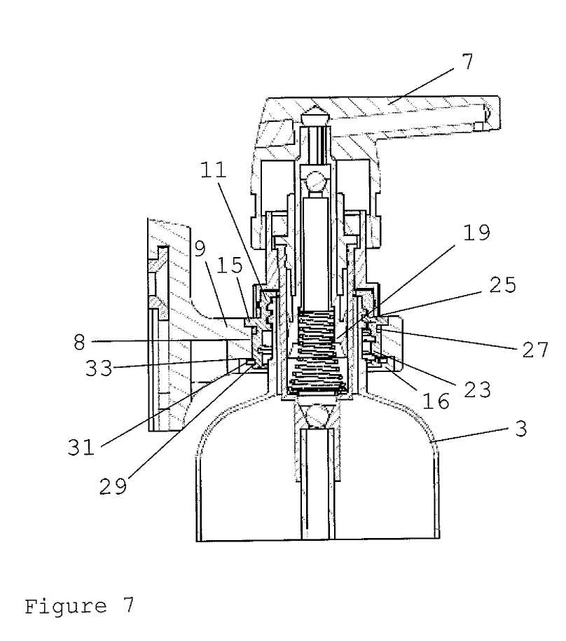

FIG. 7 shows a cross-section along line A-A of the liquid dispenser shown in FIG. 4 for a second embodiment of the invention. Features in common with the first embodiment are given the same reference numbers and description thereof is not repeated.

In a second embodiment of the invention, as illustrated in FIG. 7, the locking member 11 is provided with first 23 and second 25 screw threads which are axially separated along the aperture 19 of the locking member 11, and which have different internal diameters (i.e. across the aperture 19 of the locking member 11). In this embodiment, first screw thread 23 with an internal diameter of 28 mm is provided on the locking member 11 towards the end of the bore 8 of the body part 9 that receives the neck of the container 3. Second screw thread 25 with an internal diameter of 24 mm is provided on the locking member 11 towards the other end of the bore 8.

Thus, when a neck of a container 3 having a screw thread with a diameter of 28 mm is inserted into the aperture 19 of the locking member 11, and the locking member 11 is rotated within the bore 8 relative to the body part 9, the first screw thread 23 engages with the screw thread on the neck of the container 3 to secure the locking member 11 to the neck of the container 3. Similarly, when a neck of a container 3 having a screw thread with a diameter of 24 mm is inserted into the aperture 19 of the locking member 11, and the locking member 11 is rotated, the second screw thread 25 engages with the screw thread on the neck of the container 3 to secure the locking member 11 to the neck of the container 3. Thus, containers 3 with necks having screw threads with internal diameters of 24 mm or 28 mm can be secured to the locking member 11, and thereby connected to the liquid dispenser 1.

In other embodiments of the invention, first and second screw threads with internal diameters different to 24 mm or 28 mm may be present. Alternatively, in some embodiments more than two screw threads with different internal diameters may be provided on the locking member.

In the second embodiment, the locking member 11 has a circumferential groove around its outer circumference, and an O-ring 27 is partly received within the circumferential groove. The O-ring 27 is resiliently deformed between the locking member 11 and the bore 8 of the body part 9. Compression of the O-ring 27 between the locking member 11 and the bore 8 causes resistance to rotation of the locking member 11 within the bore 8. Thus, a user must apply a rotational force to the locking member 11 greater than the resistive force caused by the compression of the O-ring 27 in order to rotate the locking member 11 in the bore 8 relative to the body part 9. Therefore, undesired or unintentional rotation of the locking member 11 within the bore 8 of the body part 9, for example when the liquid dispenser 1 is being used by a user to dispense liquid, can be prevented.

In the second embodiment, the locking member 11 has a second circumferential groove 29 about its external circumference, adjacent to a lower axial end of the locking member 11. A circlip 31 is engaged with the groove 29 of the locking member 11 and extends into the recess 16, which extends circumferentially around the inner surface of the bore 8, so that it abuts an axially upper face 33 of the recess 16. Thus, the locking member 11 is prevented from being displaced axially along the bore 8 of the body part 9 in an upwards direction when the circlip 31 is engaged with the groove 29 of the locking member 11. The locking member 11 is prevented from being displaced axially along the bore 8 of the body part 9 in a downwards direction by the flange 15, as in the first embodiment.

The circlip 31 is releasable to disengage the groove 31 of the locking member 11. When the circlip 31 is released, the locking member 11 is freely displaceable axially along the bore 8 of the body part 9 in an upwards direction, allowing the locking member 11 to be removed from the bore 8 of the body part 9. In this manner, the locking member 11 can be releasably held in the bore 8 of the body part 9.

In other embodiments, the circlip 31 may be replaced with lugs 17, as described above in relation to the first embodiment.

The second embodiment has a conventional spring-loaded pump system 7, as known to a person skilled in the art and as described above in relation to the first embodiment. The pump system 7 gains access to the liquid contents of the container 3 through the aperture 19 of the locking member 11

A circumferential groove and O-ring as described above in relation to the second embodiment may similarly be included in the first embodiment of the invention. Similarly, a releasable circlip as described above in relation to the second embodiment may be included in the first embodiment in place of the lug arrangement.

What is claimed is:

1. A container retainer for mounting a container to a surface, the container retainer comprising:
a body part having a bore therethrough;
a rotatable locking member extending into the bore; and
means holding the locking member in the bore to resist movement of the locking member in the direction of the axis of the bore;
the locking member having an aperture therethrough for receiving a neck of the container, and means within the aperture for securing the locking member to the neck on rotation of the locking member in the bore relative to the body part; and
means for mounting the body part to the surface.

2. A container retainer according to claim 1, wherein the locking member is releasably held in the bore.

3. A container retainer according to claim 2, wherein there is at least one recess in the surface of the bore, and the holding means comprises at least one deformable lug on the locking member, which lug is received in the at least one recess to hold the locking member in the bore and is deformable to a position in which the lug is clear of the recess to allow release of the locking member from the body part.

4. A container retainer according to claim 2, wherein the holding means includes a circlip engaged with the locking member.

5. A container retainer according to claim 4, wherein the locking member has a circumferential groove in which the circlip is received.

6. A container retainer according to claim 1, wherein the holding means includes a flange on the locking member, which flange abuts the body part adjacent one end of the bore, to resist axial movement of the locking member relative to the bore in an axial direction of the bore.

7. A container retainer according to claim 6, wherein the body part has a groove in which said flange is received, thereby to resist radial movement of the locking member in the bore.

8. A container retainer according to claim 1, wherein the locking member has a grip part outside the bore to allow a user to rotate the locking member in the bore.

9. A container retainer according to claim 1, wherein the means for securing the locking member to the neck of the container is a screw thread engagable with a corresponding screw thread on the neck of the container.

10. A container retainer according to claim 9, wherein the means for securing the locking member to the neck of the container comprises a plurality of screw threads with different internal diameters, each screw thread being located at a different axial position in the aperture of the locking member.

11. A container retainer according to claim 10, wherein the means for securing the locking member to the neck of the container comprises a first screw thread with an internal diameter of 24 mm and a second screw thread with an internal diameter of 28 mm.

12. A container retainer according to claim 1, wherein a resilient member is provided between the locking member and the bore to resist rotation of the locking member relative to the body part.

13. A container retainer according to claim 1, further including a pump unit received in the aperture of the locking member.

14. A kit of parts for constructing a liquid dispenser, comprising:
a support unit, the support unit comprising a body part having a bore therethrough and means for mounting the body part to a surface;
a retention unit, the retention unit comprising a rotatable locking member receivable into the bore and means for holding the locking member in the bore to resist movement of the locking member in the direction of the axis of the bore, the locking member having an aperture therethrough for receiving a neck of a container and means within the aperture for securing the locking member to the neck on rotation of the locking member; and a pump unit receivable in the aperture of the locking member for dispensing liquid from the container.
